(19) United States
(12) Patent Application Publication
(10) Pub. No.: US 2014/0116992 A1
(43) Pub. Date: May 1, 2014

(54) Welding Enclosure

(71) Applicant: SAFE ARC TECHNOLOGY, LLC, Lafayette, LA (US)

(72) Inventors: David E. Walker, Lafayette, LA (US); Chad L. Bourgeois, Lafayette, LA (US)

(21) Appl. No.: 14/063,323

(22) Filed: Oct. 25, 2013

Related U.S. Application Data
(60) Provisional application No. 61/718,372, filed on Oct. 25, 2012.

(51) Int. Cl. B23K 9/32

(52) U.S. Cl. CPC B23K 9/321; B23K 9/325
USPC 219/72; 219/130.21; 454/49

(57) ABSTRACT

A personal welding enclosure has a rigid support frame and a tent-like enclosure defining an inner work chamber. The enclosure, which is supported by the rigid frame, is beneficially formed from impermeable, flame-proof and/or flame-resistant fabric having desired strength, durability and thermal insulation characteristics. A pneumatic automatic shut off control system monitors variables in and around the enclosure, alerts personnel to the existence of potentially unsafe conditions within the enclosure and automatically terminates welding and/or other hot-work when an unsafe condition is detected.

### CROSS REFERENCES TO RELATED APPLICATION

PRIORITY OF U.S. PROVISIONAL PATENT APPLICATION Ser. No. 61/718,372, FILED Oct. 25, 2012, INCORPORATED HEREIN BY REFERENCE, IS HEREBY CLAIMED.

### STATEMENTS AS TO THE RIGHTS TO THE INVENTION MADE UNDER FEDERALLY SPONSORED RESEARCH AND DEVELOPMENT

NONE

### BACKGROUND OF THE INVENTION

1. Field of the Invention

The present invention pertains to an enclosure for use during welding operations. More particularly, the present invention pertains to a personal welding enclosure for use during welding operations on oil and gas platforms, refineries, industrial facilities and other similar installations.

2. Brief Description of the Prior Art

Pressurized welding enclosures, or so-called “PWE's”, have been used for some time. Although the use of such PWE's can vary, in many cases such PWE's are used to create a temporary enclosure for conducting welding operations, particularly in environments where there is a risk of fire or explosion. By way of illustration, but not limitation, such environments can include offshore oil and gas platforms or rigs, refineries or petrochemical plants, and/or industrial facilities and other similar installations. Generally, such PWE's are designed to isolate welding operations from a surrounding environment including, without limitation, any flammable or hazardous gases or fumes.

Conventional PWE's are frequently constructed or otherwise fabricated from individual wooden boards or other similar building materials at a particular location and then dismantled after use. Such fabrication and dismantling of conventional PWE's are typically very time consuming and labor intensive. Moreover, the design of such conventional PWE's is often not well suited for many applications.

Conventional PWE's are frequently equipped with automatic shut off systems; in the event that a potentially unsafe condition is detected, such systems automatically terminate certain systems within the PWE, while alerting personnel to the existence of a potential problem. Such conventional automatic shut off systems typically utilize computer processors (often laptop computers), electrical components and/or electrical distribution panels that are hard-wired to electrical sensors other components, all of which work off of electrical signals. Said devices/components generally must be operated in a safe environment some distance away from the PWE due to the risk of creating a spark that could ignite hazardous gases or fumes.

Thus, there is a need for a PWE that can be quickly and efficiently constructed on a location, and dismantled after use. Further, the PWE should include an automatic shut down system that does not utilize computer processors, electrical components, electrical distribution panels and/or other electrical devices that could generate sparks which, in turn, could ignite flammable or hazardous gases or fumes.

### SUMMARY OF THE INVENTION

The present invention comprises a pressurized enclosure assembly for use during welding and/or other hot work, particularly in environments where there is a risk of fire or explosion. The pressurized enclosure assembly of the present invention can be used in any number of different applications or environments. By way of illustration, but not limitation, it is to be observed that the enclosure system of the present invention can be used on offshore oil and gas platforms or rigs, refineries or petrochemical plants and/or industrial facilities and other similar installations.

In the preferred embodiment, the pressurized enclosure assembly of the present invention comprises a rigid frame; although the precise configuration of said rigid frame can vary, it is to be observed that said frame can comprise a plurality of connectable tubular members. Said rigid frame can be constructed in many different configurations, and can be customized to conform to space limitations or other characteristics of particular work environments.

A substantially flexible tent-like member is supported from said rigid metal frame to form a pressurized enclosure defining an inner chamber. Said tent-like enclosure is beneficially formed from impermeable, flame-proof or flame-resistant fabric having desired strength, durability and thermal insulation characteristics. By way of illustration, but not limitation, said tent-like enclosure can be constructed from double plain weave silica fabric, such as AVSil™ Double Plain Weave Silica marketed by AVS Industries, LLC.

The present invention monitors a work environment within said pressurized enclosure assembly using an automatic shut off control system (“ASO”). In the event that an unsafe condition is detected, the ASO automatically terminates hot-work within said pressurized enclosure assembly and alerts personnel to the existence of potentially unsafe conditions within said pressurized enclosure assembly. Such unsafe conditions can include, without limitation, the following: loss of positive pressure within the enclosure; detection of gas concentrations within the enclosure falling outside of certain predetermined ranges; detection of explosive gases at or near the intake of the enclosure; activation of an emergency shut-down (“ESD”) system; and/or loss of power to the ASO.

Upon detecting an unsafe condition or other predetermined measured value, the ASO automatically terminates hot-work by opening at least one control valve, thereby releasing static air pressure and actuating pneumatic valves that control the operation of hot-work equipment. Additionally, at least one alarm system within the pressurized enclosure assembly provides a visual and audible alarm to personnel situated inside the pressurized enclosure assembly.

### BRIEF DESCRIPTION OF DRAWINGS/FIGURES

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts an overhead perspective view of a pressurized welding enclosure of the present invention.

FIG. 2 depicts an overhead sectional view of a pressurized welding enclosure of the present invention.

FIG. 3 depicts a side sectional view of a pressurized welding enclosure of the present invention.

FIG. 4 depicts a schematic illustration of the pneumatic automatic shut off operating system of the present invention.

### DETAILED DESCRIPTION OF A PREFERRED EMBODIMENT

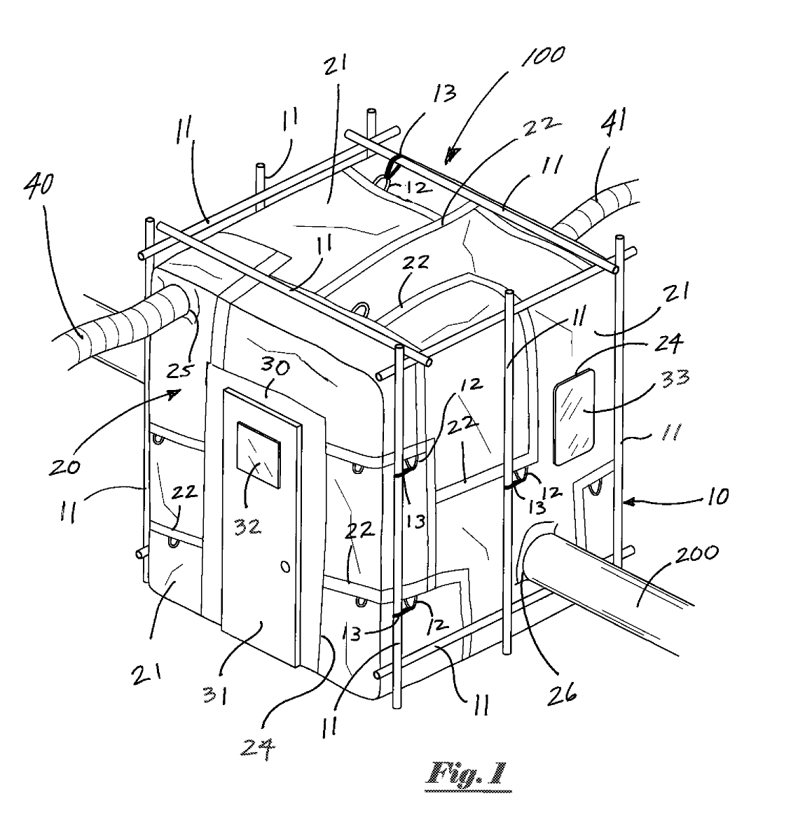

FIG. 1 depicts an overhead perspective view of a welding enclosure assembly 100 of the present invention. Said pressurized enclosure assembly 100 is adapted for use in connection with welding and/or other hot work, particularly in environments where there is a risk of fire or explosion. By way of illustration, but not limitation, it is to be observed that the pressurized enclosure assembly 100 of the present invention can be used on offshore oil and gas platforms or rigs, refineries, petrochemical plants and/or industrial facilities and other similar installations.

In the preferred embodiment, pressurized enclosure assembly 100 of the present invention comprises a rigid structural frame assembly 10; although the precise configuration of said rigid frame assembly can vary, it is to be observed that said rigid frame assembly 10 can comprise a plurality of connectable individual frame members 11. Said individual frame members 11 can be joined or connected in many different configurations to form frame assembly 10, and can be customized to conform to space limitations or other characteristics of particular work environments. As depicted in FIG. 1, said individual frame members 11 comprise metal tubes.

Substantially flexible tent-like enclosure assembly 20 is supported from said rigid frame assembly 10. Said tent-like enclosure assembly 20 is beneficially formed from impermeable, flame-proof or flame-resistant fabric having desired strength, durability and thermal insulation characteristics, and defines an inner chamber. By way of illustration, but not limitation, said tent-like enclosure assembly 20 can be constructed from double plain weave silica fabric, such as AVSil™ Double Plain Weave Silica marketed by AVS Industries, LLC. As depicted in FIG. 1, a plurality of loops 12 attached to tent-like enclosure assembly 20 are secured to frame members 11 using fasteners 13.

Further, said tent-like enclosure assembly 20 of the present invention can be of modular construction, comprising a plurality of pre-cut panel members 21 having desired dimensions and configured in a desired pattern. Said panel members 21 can be quickly and efficiently joined or otherwise affixed together in order to form said tent-like enclosure. Said pre-cut panels 21, which can be beneficially sewn using threads or fibers constructed of para-aramid synthetic material (such as, for example, Kevlar® brand), can be quickly and efficiently joined together using hook and loop fasteners 23 (such as, for example, Velcro® brand) or other joining means in order to form tent-like enclosure assembly 20. When completed, said panel members 21 can be quickly and efficiently disassembled, transported and/or stored.

In a preferred embodiment, tent-like enclosure assembly 20 comprises a plurality of apertures or openings extending through said enclosure assembly 20 and into the inner chamber formed thereby. By way of illustration, but not limitation, said apertures include doorway opening 23 having door frame 30 disposed therein. Door 31 having door window 32 is hingedly attached to said door frame 30, and provides convenient ingress into the inner chamber formed by tent-like enclosure assembly 20 and egress therefrom. Similarly, window 33, beneficially constructed of blast-proof and/or ballistic material, can be mounted within window opening 24 to permit viewing into and out of said enclosure.

Air inlet opening 25 extends through enclosure assembly 20 and into the inner chamber formed thereby. Inlet conduit 40 is connected to said air inlet opening 25. A similar air outlet opening (not visible in FIG. 1) also extends through enclosure assembly 20 and into the inner chamber formed thereby. Outlet conduit 41 is connected to said outlet opening. Pipe member 200 extends through opening 26; in this manner, enclosure assembly 20 can be constructed around a portion of said pipe member, such that said portion of pipe member 200 is disposed within the inner chamber formed by enclosure assembly 20.

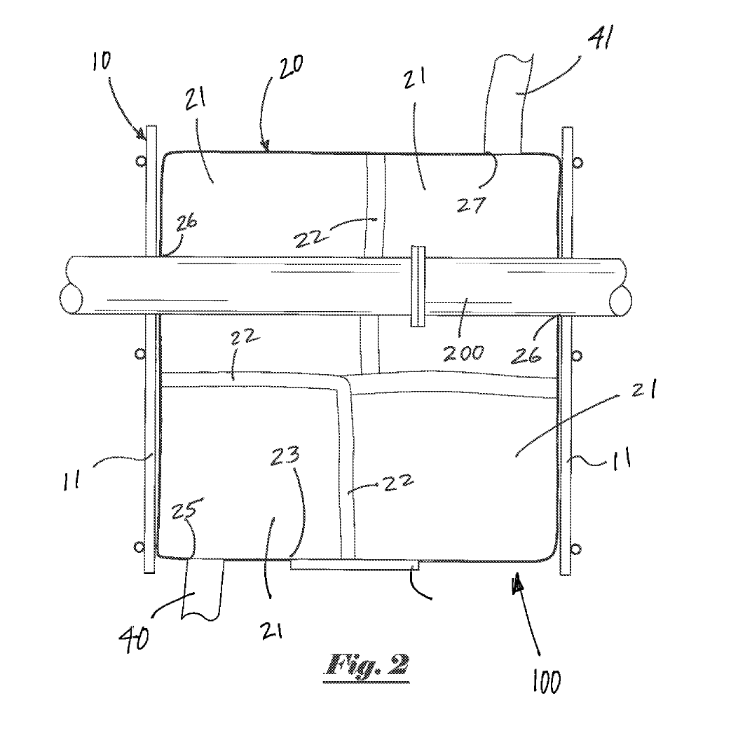

FIG. 2 depicts an overhead sectional view of a pressurized welding enclosure 100 of the present invention. In the preferred embodiment, pressurized enclosure assembly 100 of the present invention comprises a rigid structural frame assembly 10. Individual frame members 11 can be joined or connected in many different configurations to form frame assembly 10, while substantially flexible tent-like enclosure assembly 20 is supported by said rigid frame assembly 10.

As noted above, said tent-like enclosure assembly 20 is beneficially formed from impermeable, flame-proof or flame-resistant fabric having desired strength, durability and thermal insulation characteristics, and defines an inner work chamber. Said tent-like enclosure assembly 20 of the present invention is of modular construction, comprising a plurality of pre-cut panel members 21 having desired dimensions that can be quickly and efficiently joined together using hook and loop fasteners 22.

Said tent-like enclosure assembly 20 has a plurality of apertures or openings extending through said enclosure assembly 20 and into the inner chamber formed by said enclosure assembly 20, such as doorway opening 23 having door frame 30 disposed therein. Further, air inlet opening 25 extends through enclosure assembly 20 and into the inner chamber of said enclosure assembly; inlet conduit 40 is connected to said air inlet opening 25. Similarly, air outlet opening 27 also extends through enclosure assembly 20 and into the inner chamber of said enclosure assembly; outlet conduit 41 is connected to said outlet opening 27. Pipe member 200 extends through openings 26, thereby permitting enclosure assembly 20 to be constructed around and partially enclose a portion of said pipe member 200. As such, a portion of pipe member 200 is disposed within the inner work chamber formed by enclosure assembly 20.

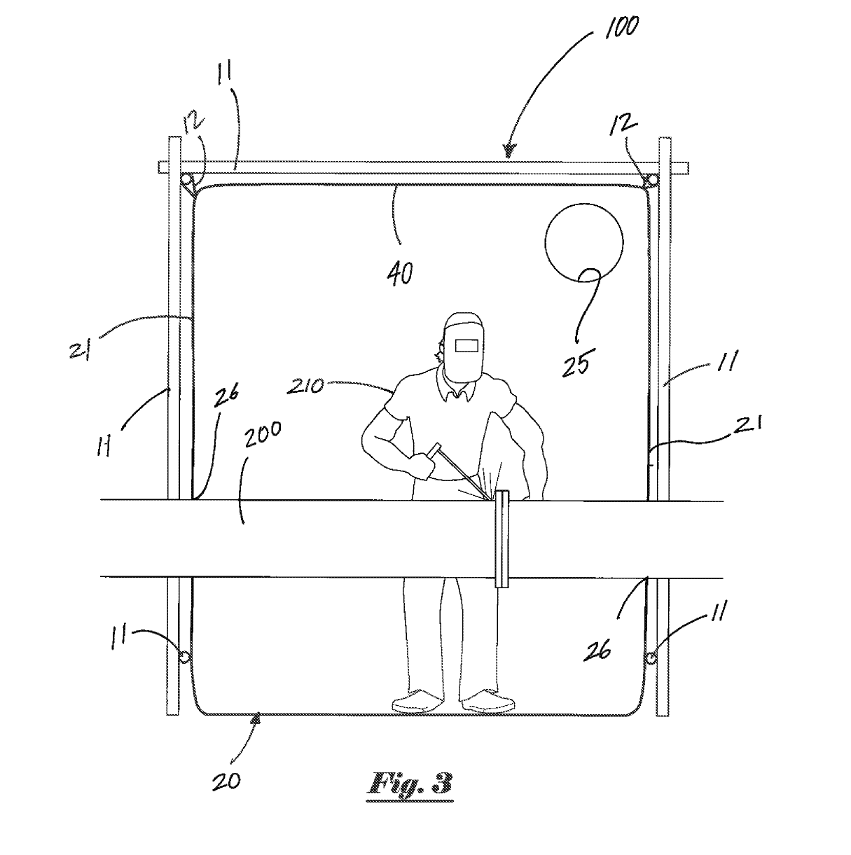

FIG. 3 depicts a side sectional view of pressurized welding enclosure 100 of the present invention in which welding or other hot-work operations are being performed on pipe member 200 by worker 210. Substantially flexible tent-like enclosure assembly 20 is formed from individual panel members 21 and is supported by rigid frame members 11. Said flexible tent-like enclosure assembly 20 defines an inner chamber 40. A plurality of loops 12 attached to said tent-like enclosure assembly 20 is secured to frame members 11. Air inlet opening 25 extends through enclosure assembly 20 and into inner chamber 40 of said enclosure assembly 20. Pipe member 200 extends through openings 26, thereby permitting enclosure assembly 20 to be constructed around and partially enclose a portion of said pipe member 200. As such, a portion of pipe member 200 is disposed within the inner work chamber 40 formed by enclosure assembly 20.

A blower or other air source is used to pump or blow air into internal chamber 40 of enclosure assembly 20 of the present invention. As such, pressure within said inner chamber 40 of tent-like enclosure assembly 20 can be maintained at a higher pressure than the pressure of the surrounding environment (that is, the pressure of the environment outside of said enclosure assembly 20). Although such outside pressure of the surrounding environment is typically atmospheric pressure, it is not required to be for the present invention to function. In a preferred embodiment, the pressure differential between inner chamber 40 and the outside of tent-like enclosure assembly 20 is maintained at all desired times such as, for example, when welding or other hot work is being performed within inner work chamber 40.

An automatic shut off control system (“ASO”) monitors the work environment within inner chamber 40 of enclosure assembly 20. In the event that an unsafe condition is detected, the ASO automatically terminates hot-work within said inner chamber 40 and alerts personnel (including, without limitation, worker 210) to the existence of potentially unsafe conditions within said inner chamber 40. Such unsafe conditions can include, without limitation, the following: loss of positive pressure within said inner chamber 40 of enclosure assembly 20; detection of gas concentrations within said inner chamber 40 of enclosure assembly 20 falling outside of certain predetermined ranges; detection of hazardous, explosive and/or flammable gases at or near the intake of inner chamber 40 of enclosure assembly 20; activation of an ESD system; and/or loss of power to the ASO.

The ASO of the present invention includes a pressure differential switch having a sensor that senses the pressure differential between inner chamber 40 of enclosure assembly 20 and the environment outside of said enclosure assembly 20. The sensor, which is connected to a switch mechanism, is beneficially located physically outside of said enclosure assembly 20. In a preferred embodiment, said sensor/switch employs a thin diaphragm that is configured to resist a certain predetermined pressure differential; in most cases, the diaphragm is set to deflect at a pressure differential greater than or equal to a predetermined value (such as, for example, 0.05 inches of water).

Said sensor/switch has “high” and “low” pressure ports, with a conduit connected to each port. The open end of the conduit connected to the “low” pressure port is exposed to the environment outside of said enclosure assembly 20, while the open end of the conduit connected to the “high” pressure port is exposed to the environment within inner chamber 40 of enclosure assembly 20. In the event that the pressure differential between inner chamber 40 of enclosure assembly 20 and the outside of said enclosure assembly 20 remains within a predetermined acceptable level, said diaphragm remains deflected so that the switch mechanism is in the “open” position. In this position, an electrical signal generated from a controller (also situated away from said enclosure assembly 20) completes an open circuit, confirming that the pressure within inner chamber 40 of enclosure assembly 20 is sufficient for welding or other hot work to be conducted safely.

In the event that the pressure differential between inner chamber 40 of enclosure assembly 20 and the pressure outside of said enclosure assembly 20 falls below a predetermined minimum acceptable level, said switch mechanism will shift to the “closed” position, thereby breaking said circuit and triggering an automatic cessation of hot work operations. Many operational parameters of the present invention, generally, and the ASO, in particular, can be adjusted to fit specific circumstances and job requirements.

In a preferred embodiment, the ASO of the present invention also monitors for unsafe conditions using at least one gas monitor unit situated within inner chamber 40 of enclosure assembly 20 to sense oxygen levels and detect the presence of explosive, flammable and/or hazardous gases within said inner chamber 40. A second gas monitor is situated at an intake air duct of said enclosure assembly 20 to detect explosive, flammable and/or hazardous gases before such gas(es) can enter inner chamber 40 of enclosure assembly 20. Importantly, the ASO of the present invention can automatically shut down blowers supplying positive air pressure to enclosure assembly 20, but only when a gas monitor located at an intake air duct of said enclosure assembly 20 detects the presence of explosive, flammable or hazardous gases, or when an ESD trigger is activated.

The ASO of the present invention beneficially comprises a “fail-safe” pneumatic system. Said pneumatic system is charged to a predetermined positive pressure (for example, 50 psig) from utility air, and must remain charged to operate and control hot work activities. All equipment and components are managed with pneumatic pressure switches that must observe a predetermined positive pressure in order to operate. Unless such predetermined positive pneumatic pressure is maintained within the said pneumatic control system, all pressure switches and control valves will automatically actuate triggering an automatic shut down event.

Further, all components of the present invention must be connected and functioning without the detection of any potentially unsafe condition in order for such control valves to remain in a “functioning” position, thereby preventing an automatic shut down event. Upon detecting an unsafe condition or other predetermined measured value, the ASO of the present invention automatically terminates hot-work (including, without limitation, welding) by actuating at least one control valve, thereby releasing static air pressure from said pneumatic control system and actuating pneumatic valves that control the operation of hot-work equipment.

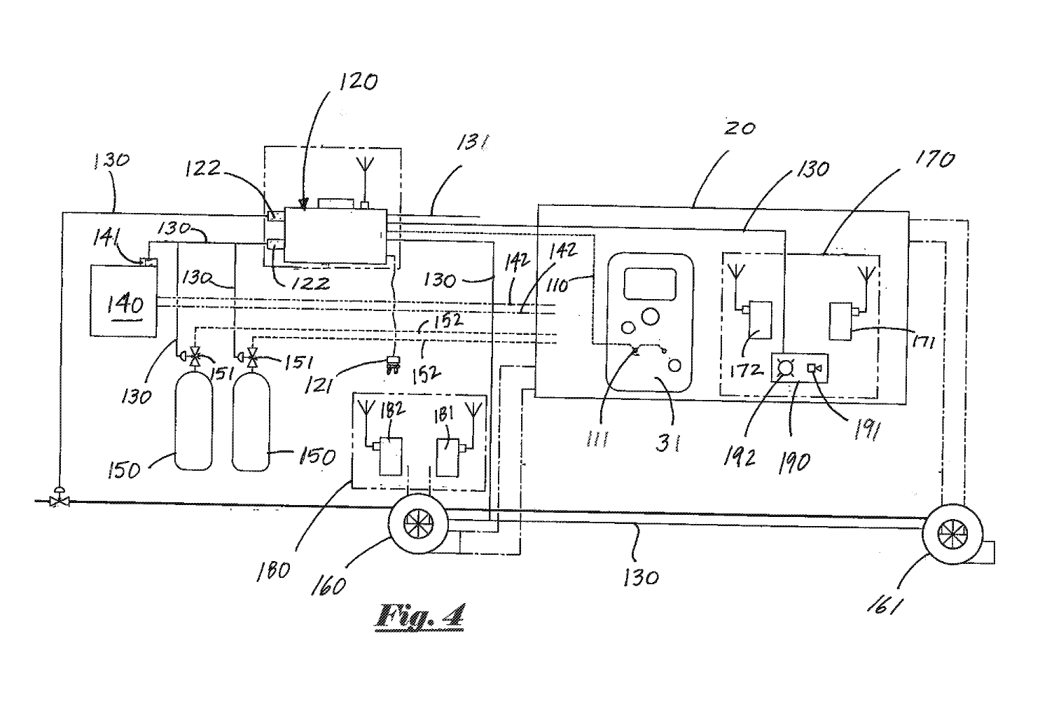

FIG. 4 depicts a schematic illustration of pneumatic ASO control system of the present invention. As noted above, said ASO monitors the work environment within the inner chamber of enclosure assembly 20. In the event that an unsafe condition is detected, the ASO automatically terminates hot-work within said inner chamber of enclosure assembly 20 and alerts personnel to the existence of potentially unsafe conditions within said enclosure assembly 20.

The fail-safe pneumatic system of the present invention comprises a plurality of tubular pneumatic control line conduits 130. Although other configurations of said pneumatic control lines 130 can be envisioned, as depicted in FIG. 4 said pneumatic control lines extend from a central controller assembly 120. Said pneumatic control lines 130 are equipped with dump valves 122 which are controlled by automated controller assembly 120.

Said pneumatic control lines 130, which can be stainless steel continuous tubing or other conduit material having desired characteristics, extend from automated controller assembly 120 to welding machine 140 and welding gas bottles 150; welding machine 140 is equipped with pressure switch 141, while welding gas bottles 150 are each equipped with gas stop valves 151. Welding lines 142 extend from welding machine 140 into enclosure assembly 20, while gas supply lines 152 extend from gas supply bottles 150 into said enclosure assembly 20. Said pressure switch 141 and gas stop valves 151 are controlled by positive air pressure within said pneumatic control lines 130.

Similarly, said pneumatic control lines 130 also extend from automated controller assembly 120 to intake air blower 160 which supplies air to enclosure 20, as well as extracting air blower 161 that moves air out of said enclosure 20. Additionally, at least one pneumatic control line 130 extends from automated controller assembly 120 to alarm assembly 190 located within the inner chamber of enclosure assembly 20.

Pneumatic control lines 130 are charged to a predetermined positive pressure (for example, 50 psig) from utility air supplied by air input line 131, which can be connected to a platform utility or other air supply source. Pneumatic control lines 130 must remain pressurized with such positive air pressure in order to permit operation of hot work activities. All equipment and components of the present invention are managed with pneumatic pressure switches that must observe said predetermined positive pressure within pneumatic control lines 130 in order to operate. Moreover, all valves on equipment used in connection with the present invention (for example, blowers, torch hoses, grinders, etc.) are maintained in a functional state during hot work operations by such positive pneumatic pressure within pneumatic control lines 130; unless such positive pneumatic pressure is maintained within said pneumatic control lines 130, such equipment cannot function. For example, such loss of positive pneumatic pressure will result in shutting of gas supply lines 152 extending from gas supply bottles 150 into said enclosure assembly 20, as well as cessation of operation of welding machine 140.

The ASO of the present invention includes a pressure differential switch having a sensor that senses the pressure differential between inner chamber of enclosure assembly 20 and the environment outside of said enclosure assembly 20. Said sensor is beneficially located physically outside of said enclosure assembly 20, such as at controller assembly 120. Conduit 110 extends from said pressure differential switch at said controller assembly 120 to an input port 111 at said enclosure assembly 20. As depicted in FIG. 4, said input port is located at door 31, thereby communicating said pressure differential switch, via conduit 110, with the pressure environment present within the inner chamber of enclosure assembly 20. A separate conduit (not visible in FIG. 4) connects said pressure differential switch to the pressure environment outside of said enclosure assembly 20.

As discussed in detail above, said pressure differential switch employs a diaphragm that is configured to resist a certain predetermined pressure differential. In a preferred embodiment, said diaphragm is set to deflect at a pressure differential greater than or equal to 0.05 inches of water. In the event that said pressure differential falls within a certain predetermined acceptable range, said switch remains in an “open” position. In this position, an electrical circuit within controller assembly 120 is completed, confirming that the pressure within the inner chamber of enclosure assembly 20 is sufficient for hot work to be conducted safely. However, in the event that the said observed pressure differential falls outside of said predetermined acceptable range, said pressure differential switch shifts to a “closed” position, thereby breaking said electrical circuit. In such an event, an automatic cessation of hot work operations is triggered by said controller assembly 120. Specifically, said controller assembly 120 actuates dump valves 122, thereby releasing static pressure within pneumatic control lines 130 and triggering an automatic shut down event.

In a preferred embodiment, the ASO of the present invention also monitors for unsafe conditions using at least one gas monitor assembly 170 situated within the inner chamber of enclosure assembly 20 to sense oxygen levels and detect the presence of explosive, flammable and/or hazardous gases within said inner chamber. Said at least one gas monitor assembly 170 beneficially comprises oxygen sensor 171 and gas sensor 172, both of which can communicate wirelessly with controller assembly 120. In the event that an unsafe condition is detected by said gas monitor assembly 170, solenoids at controller assembly 120 are actuated to release pneumatic pressure from pneumatic control lines 130, thereby triggering a system shut down and alarm event.

Similarly, an additional gas monitor assembly 180 is situated at or near an intake air duct of said enclosure assembly 20 (typically near intake blower 160) to detect explosive, flammable and/or hazardous gases before such gas(es) can enter the inner chamber of enclosure assembly 20. Said gas monitor assembly 180 beneficially comprises oxygen sensor 181 and gas sensor 182, both of which can communicate wirelessly with controller assembly 120. In the event that an unsafe condition is detected by said gas monitor assembly 180, solenoids at controller assembly 120 are actuated to drop out pneumatic pressure from pneumatic control lines 130, thereby triggering a system shut down and alarm event. Importantly, the ASO of the present invention can automatically shut down blower 160 supplying positive air pressure to the inner chamber of enclosure assembly 20, but only when said gas monitor assembly 180 detects the presence of explosive, flammable or hazardous gases or other predetermined unsafe condition entering the inner chamber of enclosure assembly 20, or when an ESD trigger is activated.

Upon detecting an unsafe condition or other predetermined measured value, the ASO of the present invention automatically terminates hot-work (including, without limitation, welding equipment and operations) by opening control valves 122, thereby releasing static air pressure within pneumatic control line 130 and actuating pneumatic valves that control the operation of hot-work equipment. Additionally, at least one alarm assembly 190 having audible alarm 191 and visible alarm indicator 192 is positioned within the inner chamber of enclosure assembly 20. Loss of positive pressure within pneumatic control line 130 extending from said alarm assembly 190 to controller assembly 120 triggers said audible alarm 191 and visible alarm indicator 192 to provide a visual and audible alarm to personnel situated within said inner chamber of enclosure 20.

The method and apparatus of the present invention do not utilize any electrical distribution panels that are hard-wired to electrical sensors enabling control of hot work or gas detectors. Additionally, the present invention does not use electrical signals to control electrical valves that would shut off or allow power to the following: blowers, electrical panel power switch, welding machines, torch hoses, or any hot work components (grinders, saws, etc), or electrical emergency shut off switches that would communicate with an electrical controller to shut in the system. Moreover, the welding enclosure assembly of the present invention is fully compliant with applicable regulatory requirements including, without limitation, the Bureau of Ocean Energy Management, Regulation and Enforcement Pressurized Welding Enclosure Request Check-list.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

1. An enclosure assembly for performing welding and other hot work comprising:
a) a substantially flexible enclosure defining an inner chamber, said enclosure having at least one inlet and at least one outlet;
b) at least one blower for supplying air to said inner chamber;
c) at least one sensor for sensing a pressure differential between said inner chamber and an area outside of said enclosure; and
d) a pneumatic control assembly for controlling at least one tools within said inner chamber, wherein said pneumatic control assembly is adapted to cease operations of said at least one tools when said at least one sensor senses a pressure differential less than a predetermined value.

2. The enclosure assembly of claim 1, further comprising a rigid support frame comprising a plurality of interconnected members.

3. The enclosure assembly of claim 2, wherein said substantially flexible enclosure is supported by said rigid support frame.

4. The enclosure assembly of claim 1, wherein said substantially flexible enclosure comprises a plurality of interconnected panel members.

5. The enclosure assembly of claim 4, wherein said interconnected panel members are joined with hook and loop fasteners.

6. The enclosure assembly of claim 1, wherein said substantially flexible enclosure comprises double plain weave silica fabric.

7. The enclosure assembly of claim 1, wherein said double plain weave silica fabric is sewn with para-aramid synthetic material.

8. An enclosure assembly for performing welding and other hot work comprising:
a) a rigid support frame comprising a plurality of interconnected members;
b) a substantially flexible enclosure defining an inner chamber, wherein said enclosure is supported by said rigid support frame and has at least one inlet and at least one outlet; and
c) at least one blower situated outside of said enclosure for supplying air to said inner chamber.

9. The enclosure assembly of claim 8, further comprising a pneumatic control assembly for controlling operation of said at least one blower, and at least one tool within said inner chamber.

10. The enclosure assembly of claim 8, wherein said substantially flexible enclosure comprises a plurality of interconnected panel members.

11. The enclosure assembly of claim 10, wherein said interconnected panel members are joined with hook and loop fasteners.

12. The enclosure assembly of claim 8, wherein said substantially flexible enclosure comprises double plain weave silica fabric.

13. The enclosure assembly of claim 8, wherein said double plain weave silica fabric is sewn with para-aramid synthetic material.

14. The enclosure assembly of claim 9, wherein said pneumatic control assembly further comprises at least one sensor for sensing a pressure differential between said inner chamber and an area outside of said enclosure, wherein said pneumatic control assembly is adapted to cease operations of said at least one blower and said at least one tool when said at least one sensor senses a pressure differential less than a predetermined value.

15. The enclosure assembly of claim 9, wherein said pneumatic control assembly further comprises at least one gas detector for sensing the presence of explosive, flammable or hazardous gas, wherein said pneumatic control assembly is adapted to cease operations of said at least one tool when said at least one gas detector detects a predetermined concentration of explosive, flammable or hazardous gas.

16. The enclosure assembly of claim 15, wherein said at least one gas detector is positioned at an air intake of said at least one blower.

17. The enclosure assembly of claim 15, wherein said at least one gas detector is positioned within said substantially flexible enclosure.

18. The enclosure assembly of claim 15, wherein said at least one gas detector is adapted to wirelessly communicate with said pneumatic control assembly.

19. An enclosure assembly for performing welding and other hot work comprising:
a) a rigid support frame comprising a plurality of interconnected members;
b) a substantially flexible enclosure defining an inner chamber, wherein said enclosure is supported by said rigid support frame and has at least one inlet and at least one outlet;
c) at least one blower for supplying air to said chamber;
d) a pneumatic control assembly for controlling operation of said at least one blower and at least one tool within said inner chamber;
e) at least one sensor situated outside of said enclosure for sensing a pressure differential between said inner chamber and an area outside of said enclosure, wherein said pneumatic control assembly is adapted to cease operations of said at least one blower and said at least one tool when said at least one sensor senses a pressure differential less than a predetermined value;
f) a plurality of gas detectors for sensing the presence of explosive, flammable or hazardous gas, wherein said pneumatic control assembly is adapted to cease operations of said at least one tool when a gas detector detects a predetermined concentration of explosive, flammable or hazardous gas.

20. The enclosure assembly of claim 19, wherein said at least one gas detector is positioned at an air intake of said at least one blower and at least one gas detector is positioned within said substantially flexible enclosure.
